(19) United States
(12) Patent Application Publication
(10) Pub. No.: US 2022/0025685 A1
(43) Pub. Date: Jan. 27, 2022

(54) DOOR LOCK

(71) Applicant: Patrick John Doherty, Littleborough, Greater Manchester (GB)

(72) Inventor: Patrick John Doherty, Littleborough, Greater Manchester (GB)

(21) Appl. No.: 17/312,047

(22) PCT Filed: Dec. 11, 2019
(86) PCT No.: PCT/GB2019/053509

§ 371 Date: Jun. 9, 2021

(30) Foreign Application Priority Data
Dec. 13, 2018 (GB) 1820391.9
Apr. 24, 2019 (GB) 1905701.7
Jun. 12, 2019 (GB) 1908409.4
Oct. 30, 2019 (GB) 1915746.0

(51) Int. Cl. E05C 19/18

(52) U.S. Cl. CPC E05C 19/182; E05C 19/188

(57) ABSTRACT

A portable door locking device having a locking bar with a first section and a second section. The second section is pivotally connected to the first section, with the second section being provided with at least one section of enlarged thickness. A resiliently yieldable section is provided and the locking bar is at least partially received within the resiliently yieldable section.

The present invention relate to portable door locks which are designed to engage the strike plate of a door frame and the inner surface of a door and act to lock the door from the inside.

Conventionally, portable locks use a thin, threaded metal bar with a hooked end, the bar locates in the gap between the opening side of the door and door frame and the hooked end locates in the latch opening in the strike plate secured to the door frame. The thin threaded bar projects outwards from the inner surface of the door. A blocking member is mounted on the projecting portion of the thin threaded bar, the blocking member bridges the gap between the inner surface of the door and door frame, said blocking member is locked against transverse movement on the thin bar by a threaded member, thereby, preventing the door from opening.

Devices of this general type are usually complicated or do not exert constant pressure upon the door to prevent the device rattling. Many such devices are not suitable for doors of different thicknesses, furthermore, the majority of portable locks of this type do not provide much resistance to forced entry relying solely on the integrity of the anchor points of the strike plate and the integrity of the lock, such locks are very mechanical in appearance and structure and not for example, suitable for a lady to carry in her handbag.

It is an object of the present invention to provide an improved portable door lock which will mitigate the above shortfalls associated with portable door locks of this type, a lock that provides a much higher degree of security and is aesthetically designed and sized to be convenient for carrying in a pocket, purse, or handbag.

### STATEMENT OF INVENTION

According to the present invention there is provided a door locking device as set out in accompanying claim 1. Preferred features are set out in the sub-claims.

Thus, the present invention may be in the form of a door locking device comprising:
a locking bar having a first section and a second section pivotally connected to the first section, the second section being provided with a protrusion; and
a housing which comprises a strong compression spring having a first end comprising a face and a recess provided therein;
wherein the second section of the locking bar is received, and retained, within the recess of the spring housing, and
wherein the pivotal connection is orientated with an axis of rotation that is non-parallel with the longitudinal axis of the locking bar.

Preferably, the pivotal connection is transverse with the longitudinal axis of the locking bar.

Preferably, the housing is manufactured from spring steel wire or other dampening means capable of absorbing an impact force that is applied to the door whose opening has been limited.

The face of the spring housing is provided with a protective material, which may comprise one or more of: plastics material; rubber and elastomeric material; and this material may be in the form of a plug or insert of protective material that is received within the spring housing and forms the face of the housing. The protective material reduces the risk of damage to the door when the device is in use by cushioning the contact area between the housing and the door.

Advantageously, a second end of the housing may be substantially closed. The housing may be open at one end to receive the locking bar and closed at the other end to prevent damage to the locking bar and/or the connection between the housing and the locking bar.

It is preferable that the face of the spring housing and the recess therein are set back from the end of the housing such that, when the locking bar is received within the recess of the housing, the pivot connection of the locking bar is positioned within the end of the housing. Having a pivot connection located within the housing provides protection to the pivot mechanism whilst also allowing the locking bar to pivot. The housing may be employed to limit the range of motion of the pivot connection.

The housing comprises the first part of a connection mechanism and a cover or lid section is provided with the cover section comprising a second part of the connection mechanism, and wherein the respective parts of the connection mechanism are engaged, at least part of the locking bar that extends from the housing is received within the cover section, and, advantageously, when the housing and cover are engaged with one another, the device is capsule in shape. The use of a cover section reduces the risk of damage to the device or to other items when the portable door locking device is not in use. For example, if the device is stored in a handbag or purse with other items, the locking bar is protected from damage by the use of a cover section and the other items in the bag are kept from damage by the cover. The use of a capsule shape, that is to say, substantially elongate with one or both ends domed, allows the device to be well protected and an ergonomic shape that can be readily stowed in a bag or pocket.

It may be that the axial position of the protrusion of the locking bar is adjustable relative to the front face of the housing, this allows the device to be used on different door depths and sizes by allowing the distance between the housing and protrusion to be adjusted so that the distance to which the door may be opened can be altered. The adjustable distance allows a user to predetermine how far, if at all, the door can open so that they can see through the gap and determine if the door should be opened fully.

One or both ends of the locking bar may be rolled back onto itself and one or both ends may be secured thereon once rolled, with the securing, preferably, being undertaken by at least one spot weld or by clinching. Doubling over the end of the locking bar and spot welding it provides further strength to the bar and reduces the risk of the parts becoming disengaged.

The invention extends to a method of locking a door, comprising the steps of:
providing a door locking device as described herein;
placing the protrusion of the first section of the locking bar into a recess on the door frame;
closing the door such that the locking device is positioned between the door and the door frame; and
adjusting the axial position of the housing relative to the protrusion to position the spring housing close enough to the door to prevent it from being opened.

A portable door lock is provided which is compact and convenient to be carried from place to place by a traveller.

Preferably, the portable door lock comprises and is in the form of a small and compact tube or conical like enclosure when it is being stowed or not in use.

The invention will now be described further by way of example, with reference to the accompanying drawings, in which;

FIGS. 1 to 10A are views of a portable door lock in which the lock body comprises a very strong compression spring.

FIG. 1 is a side view of the door lock A.

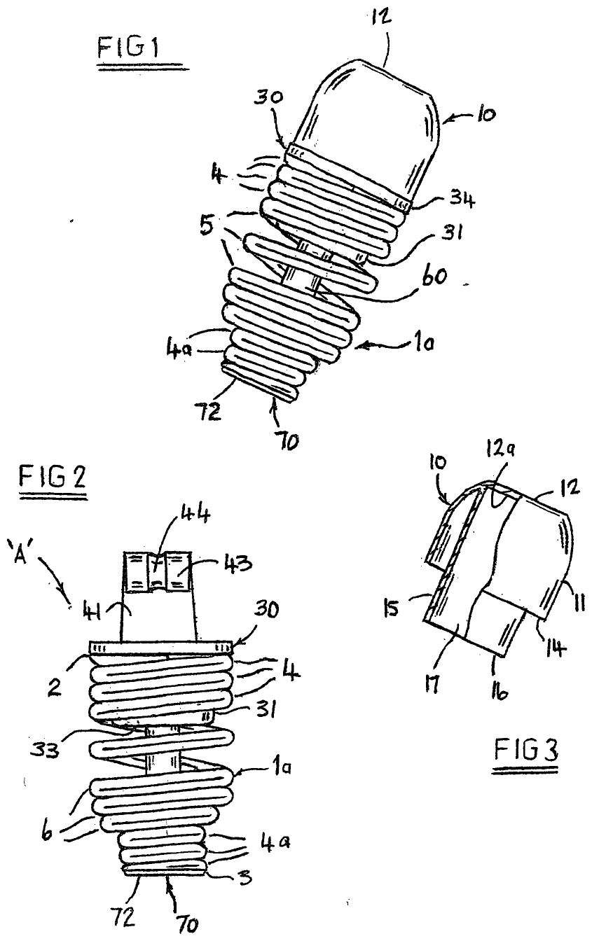

FIG. 2 is a side view of the door lock of FIG. 1 with the cover removed.

FIG. 3 is a side view of the cover of FIG. 1.

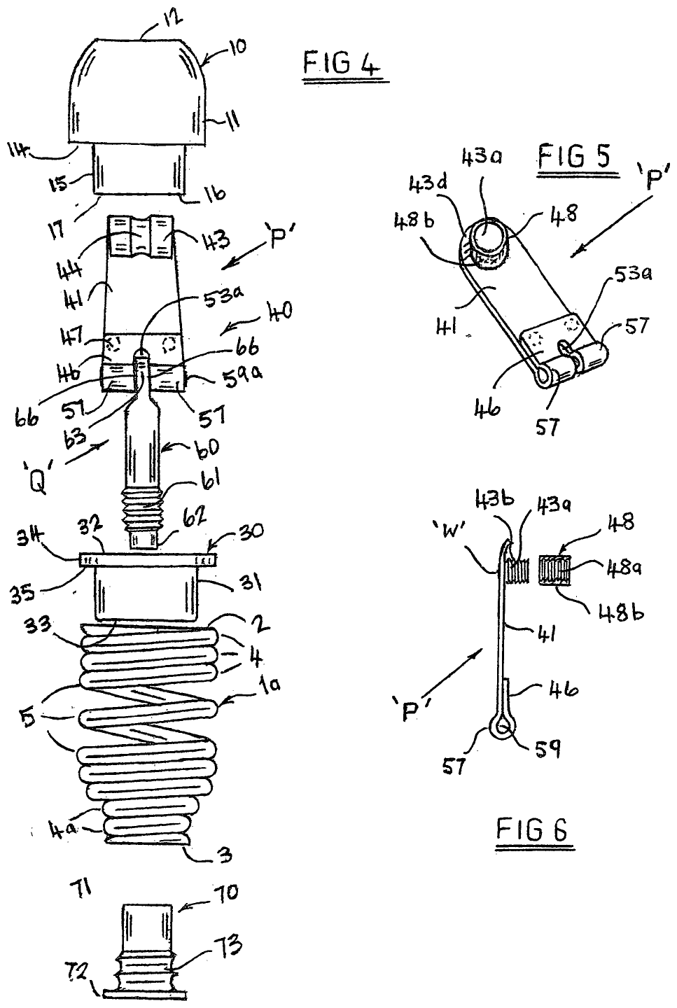

FIG. 4 is an exploded view of the components of the portable door lock of FIG. 1.

FIG. 5 is a perspective view of an alternative first section ‘p’ of the locking bar.

FIG. 6 is a part cross sectional side view of the first section ‘p’ of the locking bar of FIG. 5

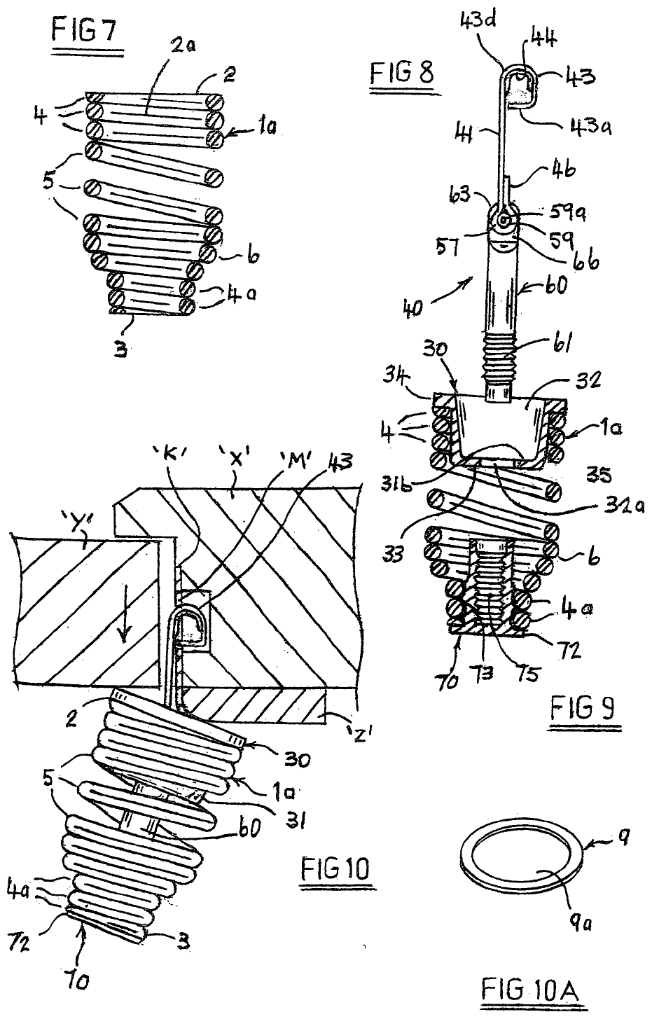

FIG. 7 is a cross sectional view of the portable lock body of FIG. 1.

FIG. 8 is a side view of the locking bar of FIG. 1.

FIG. 9 is a cross sectional view of the portable lock body of FIG. 1 with the plastic or rubber insert and threaded metal insert assembled therein.

FIG. 10 is a part cross sectional view showing the portable lock of FIG. 1 locking a door.

FIG. 10A is a perspective view of the metal washer.

FIGS. 11 to 16A are views of a further alternative door lock.

FIG. 11 is a side view of the container which houses the portable door lock B.

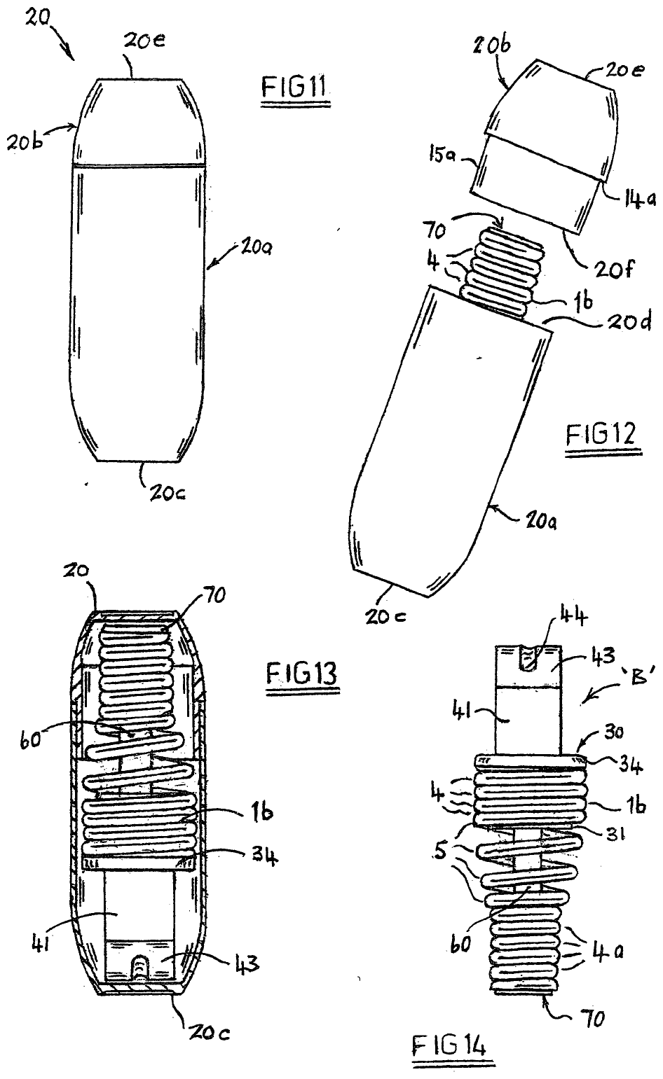

FIG. 12 is a side view of the container of FIG. 11 with the cover removed exposing the bottom end of the portable lock body 1a.

FIG. 13 is a part cross sectional side view of the assembled portable lock B of FIG. 11 inside its protective container.

FIG. 14 is a side view of the portable lock ‘B’ of FIGS. 11 to 16 after removal from its container.

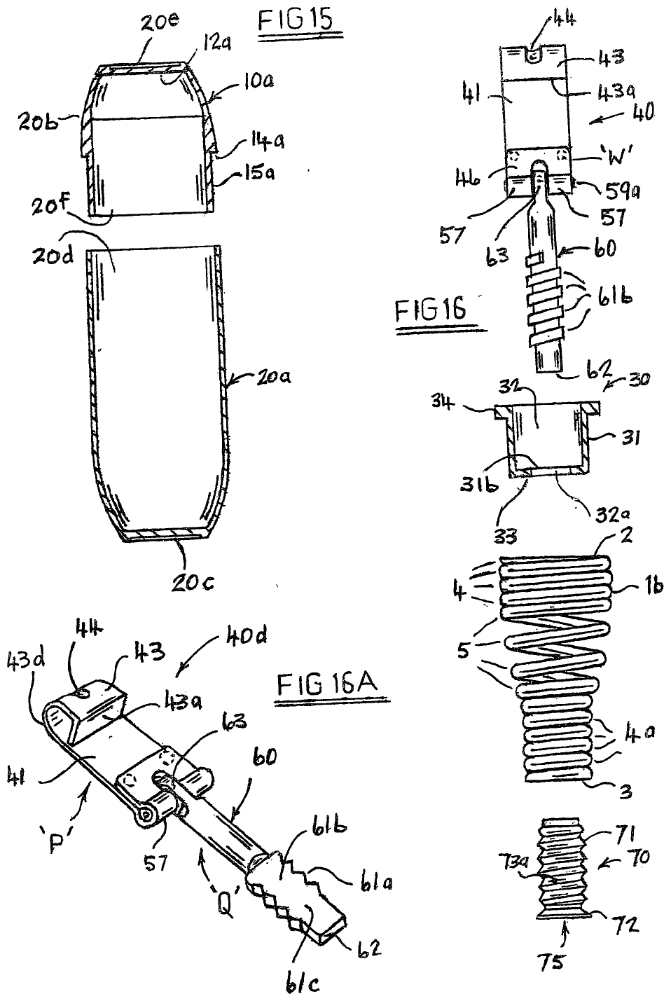

FIG. 15 is a cross sectional view of the two part portable lock container of FIG. 11.

FIG. 16 is a part cross sectional, exploded view of the components of the portable lock B of FIG. 11.

FIG. 16A is a perspective view of an alternative locking bar.

FIG. 17 is a part cross sectional side view of the portable lock C with an alternative locking bar that engages directly the spring coils of the lock body 1c.

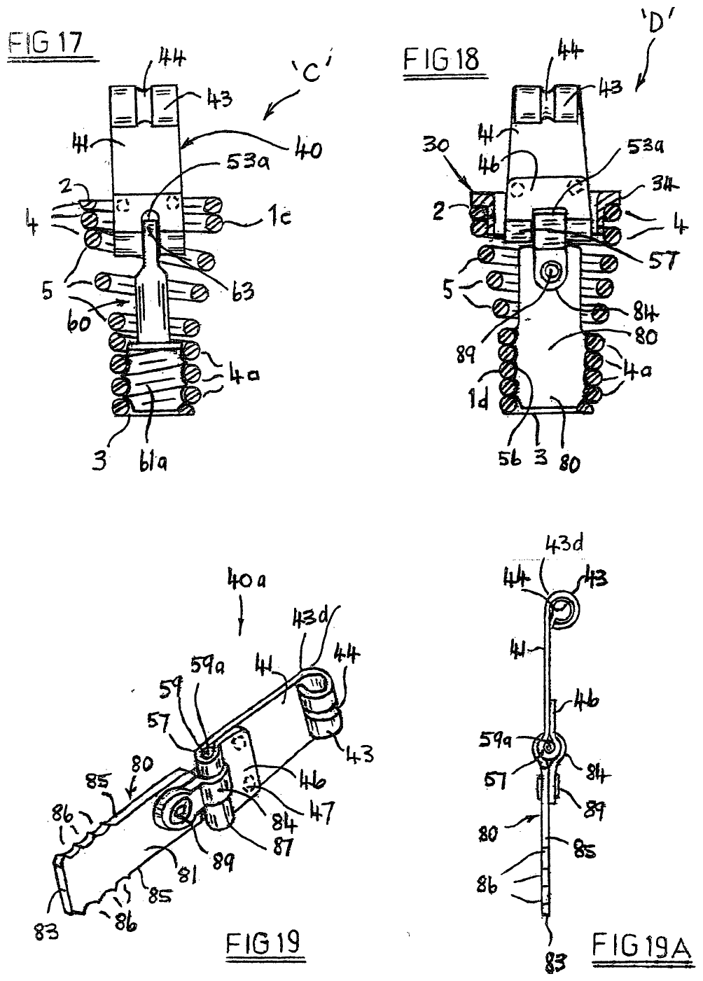

FIGS. 18 to 19A are views of the portable lock D incorporating an alternative locking bar which engaging directly the spring coils of the lock body 1d.

FIG. 18 is a part cross sectional side view showing the fully assembled door lock D.

FIG. 19 is a perspective view of the alternative locking bar of FIG. 18.

FIG. 19A is a side view of the locking bar of FIG. 18.

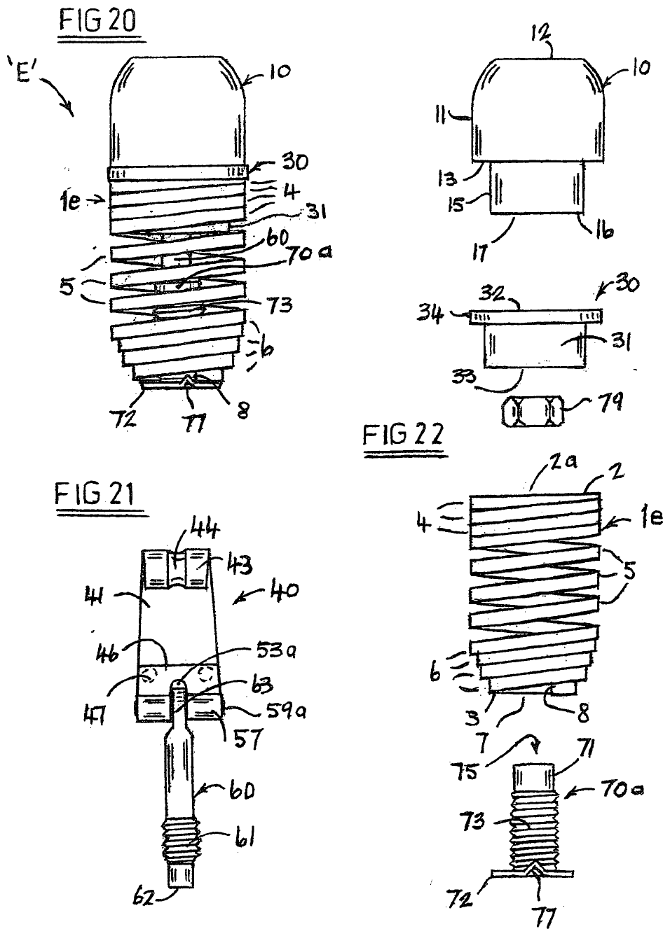

FIGS. 20 to 22 are views of an alternative portable door lock.

FIG. 20 is a side view of the assembled door lock E.

FIG. 21 is a front view of the locking bar of FIG. 20.

FIG. 22 is an exploded view showing the components of the portable door lock E of FIG. 20 minus the locking bar 40.

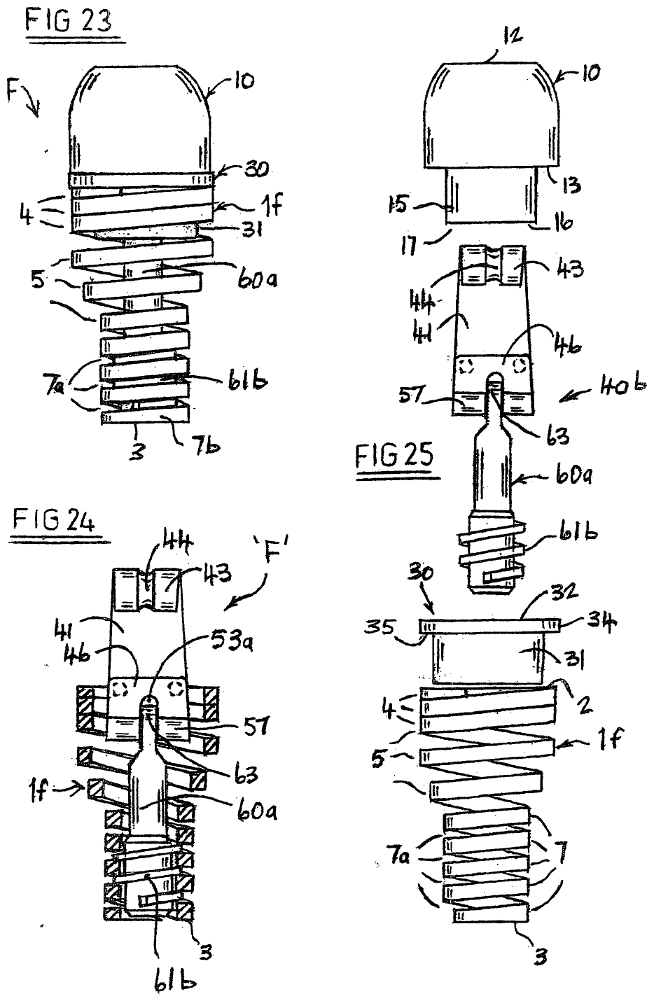

FIGS. 23 to 25 show an alternative portable door lock.

FIG. 23 is a side view of the assembled portable door lock F.

FIG. 24 is a part cross sectional side view of the portable lock of FIG. 23.

FIG. 25 is an exploded view showing the components of the portable lock of FIG. 23.

FIGS. 26 to 28 are views of an alternative portable door lock G.

FIG. 26 is a cross sectional side view of the lock body with thin walled sleeve secured therein.

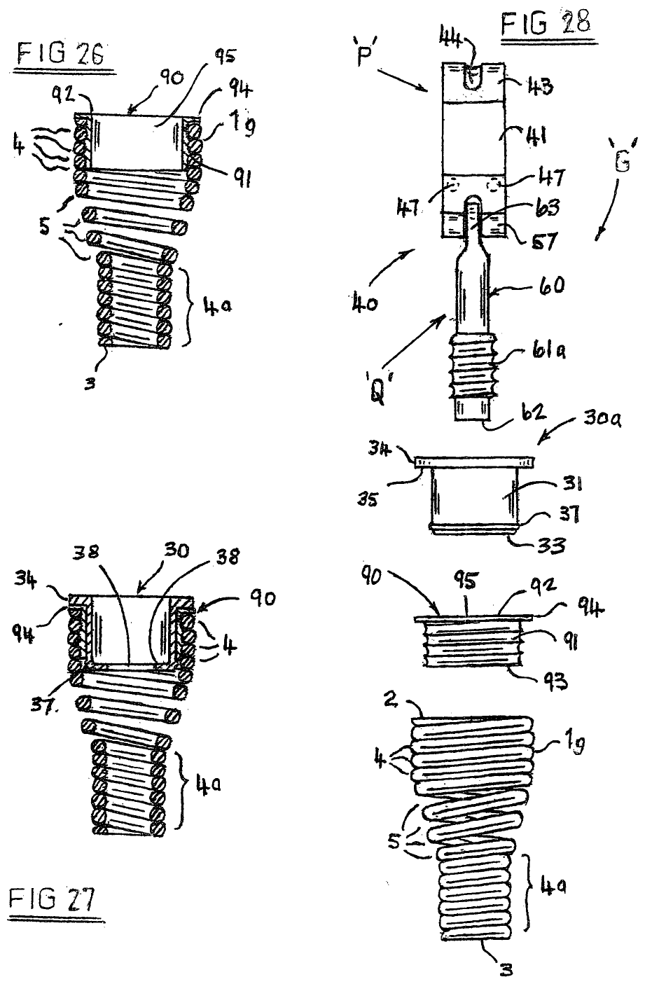

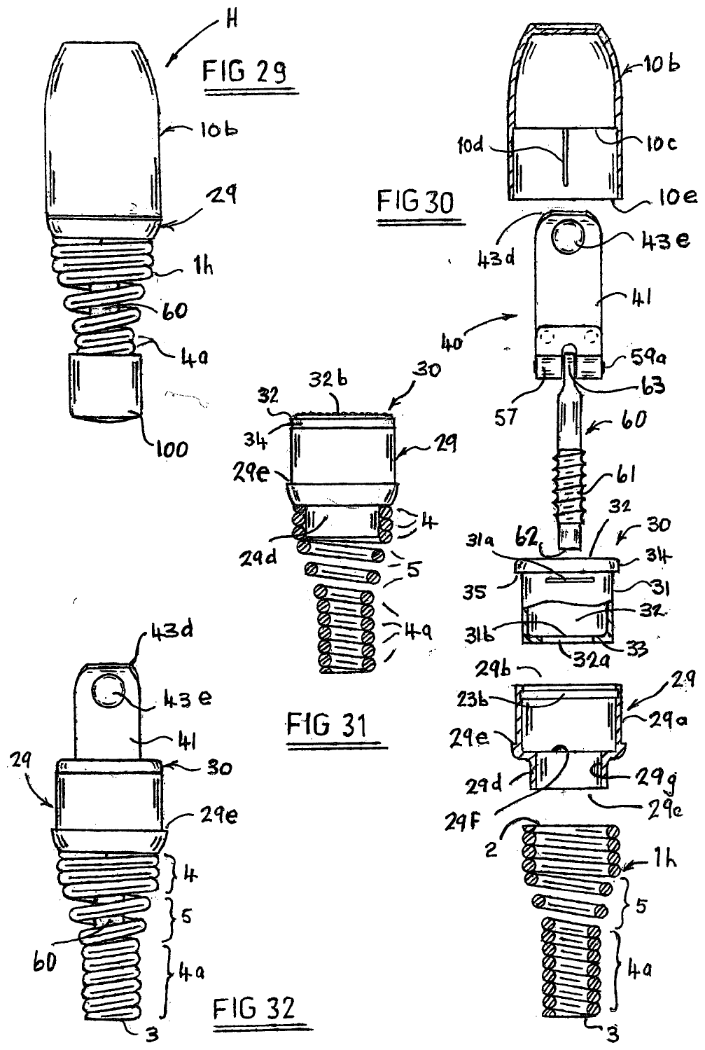

FIG. 27 is a cross sectional side view of the lock body of FIG. 30 with thin walled sleeve and plastic insert secured thereon.

FIG. 28 is an exploded side view of the components of the portable door lock G of FIGS. 26 to 28.

FIGS. 29 to 32 are views of an alternative embodiment of a portable door lock H.

FIG. 29 is a side view of the assembled door lock H.

FIG. 30 is an exploded view of the components of the portable lock of FIG. 29.

FIG. 31 is a part cross sectional side view of the body, spring and rubber insert assembly of FIGS. 29 to 32.

FIG. 32 is a side view of the portable lock of FIG. 29 prior to the cover and end cap being applied.

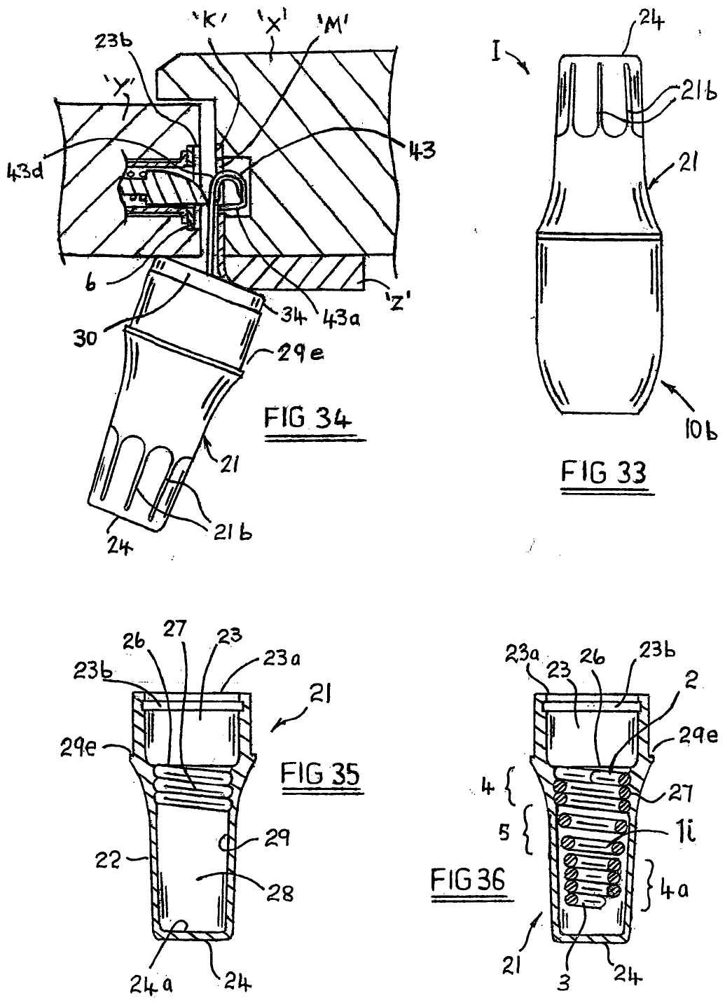

FIGS. 33 to 36 are views of an alternative door lock incorporating a spring damper element within the lock housing.

FIG. 33 is a side view of the portable lock I of FIGS. 33 to 36.

FIG. 34 is a part cross sectional view showing the portable lock of FIG. 33 locking a door.

FIG. 35 is a cross sectional view of the lock body of FIG. 33.

FIG. 36 is a cross sectional view of the lock body of FIG. 33 with the spring damper fixedly secured therein.

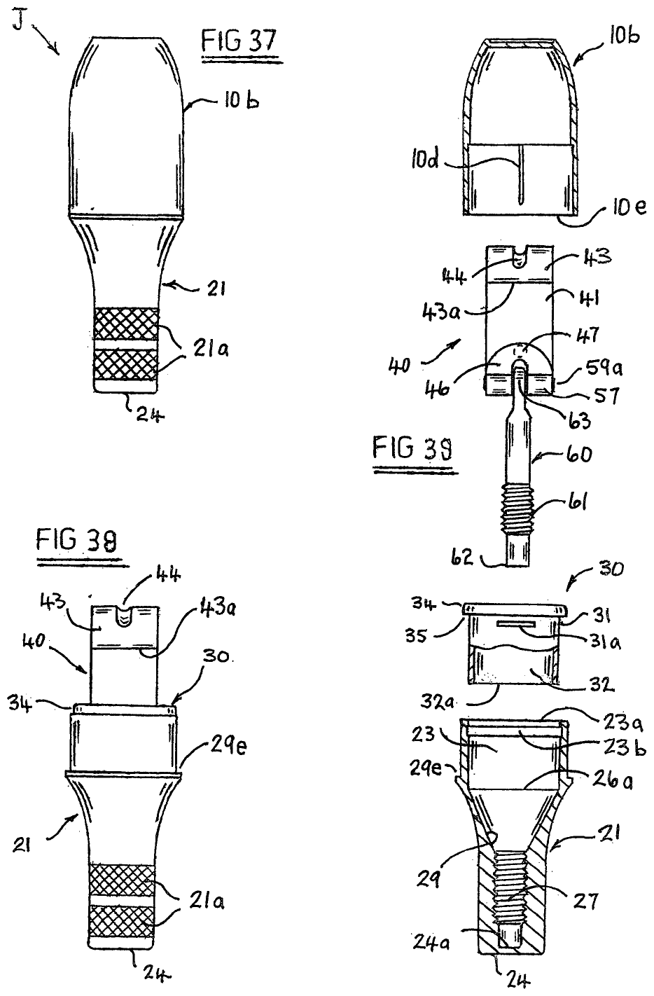

FIGS. 37 to 39 are views of a portable door lock J which does not incorporate a spring damper element.

FIG. 37 is a side view of the portable lock of FIGS. 37 to 39.

FIG. 38 is a side view of the door lock of FIG. 37 with its cover removed.

FIG. 39 is a part cross sectional exploded view of the components of the portable lock of FIG. 37.

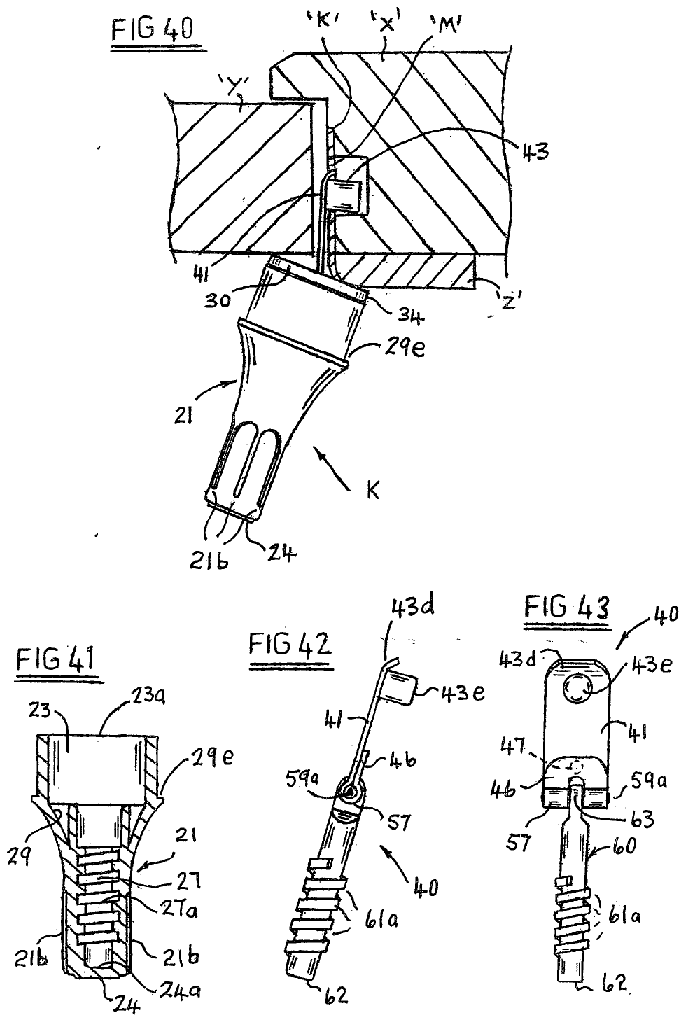

FIGS. 40 to 43 are views of a portable door lock K which does not incorporate a spring damper element.

FIG. 40 is a part cross sectional view of the door lock of FIGS. 40 to 43 locking a door.

FIG. 41 is a cross sectional view of the lock body of FIG. 40.

FIG. 42 is a side view of the locking bar of FIG. 40.

FIG. 43 is a front view of the locking bar of FIG. 42.

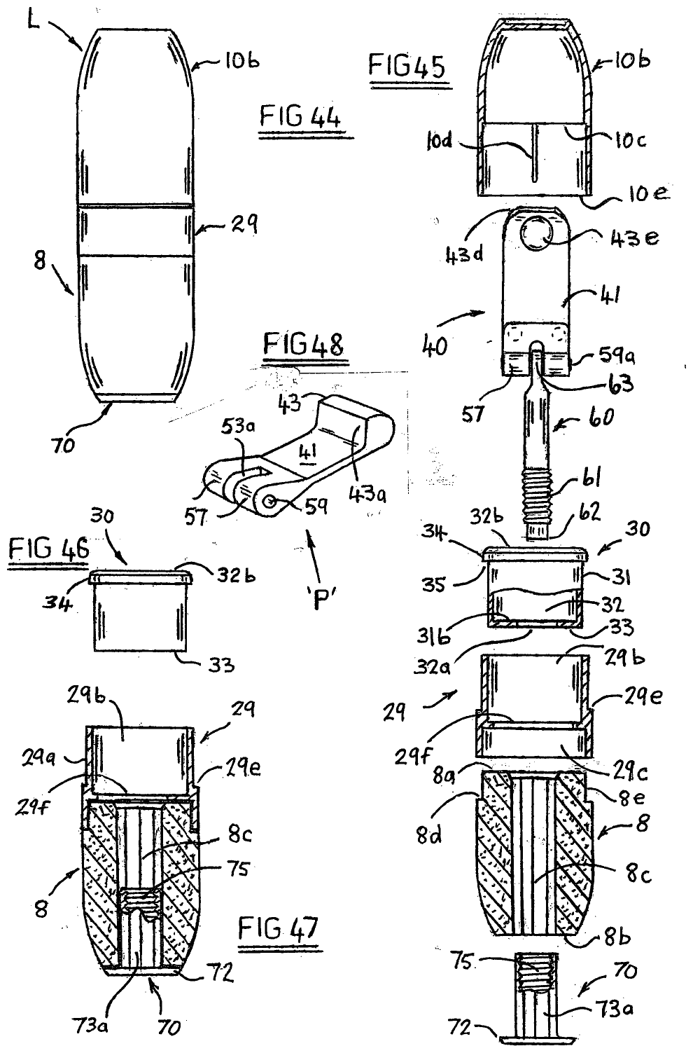

FIGS. 44 to 47 are views of a portable door lock L which incorporates a resiliently deformable material as a damper element.

FIG. 44 is a side view of the door lock of FIGS. 44 to 46.

FIG. 45 is an exploded view of the components of the portable lock of FIG. 44.

FIG. 46 is a side view of the rubber or plastic insert.

FIG. 47 is a part cross sectional view of the body, damper block and threaded insert assembly.

FIG. 48 is a perspective view of the first section ‘p’ of the locking bar which may be formed as a metal extrusion.

Referring now to FIGS. 1 to 10A, in which the lock body 1a or housing, comprises a very strong compression spring.

The portable lock ‘A’ of this example comprises a lock body 1a, a cover 10, a threaded locking bar 40, a plastic or rubber insert 30 and a metal threaded insert 70.

The portable lock body comprises a short, very strong compression spring 1a that is generally cone shaped, the front end 2 of the spring 1a comprises a number of large diameter closed spring coils 4 dimensioned to receive the plastic or rubber insert 30 which is preferably a loose fit therein and acts as the soft front face of the lock body, the lock body 1a further defines a number of open coils 5 centrally therein and arranged to provide very strong resistance to compression of the lock body 1a said open coils 5 will only come into play if the door ‘y’ is under attack by a would-be intruder. A number of closed, conical coils 6 are defined close to the back end 3 of the lock body 1a and a number of small diameter closed coils 4a comprise the back end 3 of the spring body 1a said spring coils 4a provide a very coarse internal screw thread that corresponds with the pitch of an external thread 73 defined on the threaded metal insert 70. The threaded insert 70 is screwed tightly into the spring coils 4a until its large diameter head 72 abuts the back end 3 of the lock body 1a to be fixedly secured therein [ref FIG. 9]. The metal insert 70 defines an internally threaded bore 75 to receive the threaded bolt element 60 of the locking bar 40.

The soft plastic or rubber insert 30 is generally tubular comprising a body 31 which has an outside diameter slightly smaller than the inside diameter of the lock body 1a, said insert 30 defines a flange 34 at its top end 32 with a diameter slightly larger than the outside diameter of the front end 2 of the lock body 1a. The bottom end 33 of the insert 30 is closed, apart from a small central aperture 32a which allows passage of the threaded bolt element 60 of the locking bar 40. The rubber insert 30 locates within the front end 2a of the lock body 1a, the inner face 35 of the flange 34 abuts the top end 2 of the lock body 1a said insert 30 can preferably rotate freely within and relative to the lock body 1a thereby providing a buffer between the lock body 1a and the door and door frame, rather than a rotating force. The rubber insert 30 provides the soft front face for the lock body 1a protecting the door ‘y’, door frame ‘x’ and or architrave ‘z’ from scuffing or damage. Alternatively, the insert 30 may be made of metal and for example produced as a die casting and its front face 32 provided with an elastomeric over mould 32b [ref FIG. 31] to give the insert 30 a soft front face.

The rubber or plastic insert 30 is retained in the lock body 1a by the locking bar 40 when said locking bar 40 is screwed fully into the lock body 1a for stowage after the portable lock ‘A’ has been used. As the locking bar 40 is screwed into the metal insert 70 in the lock body 1a for stowage, the rolled ends 57 of the locking bar 40 engage the inside face 31b of the bottom end 33 of the rubber insert 30, which acts to tighten the inner face 35 of the flange 34 against the front face 2 of the lock body 1a, the bottom end 33 of the insert 30 limits movement of the locking bar 40 inwards of the lock body 1a. The insert 30 may be manufactured using a glow in the dark material additive.

The threaded locking bar 40 [ref FIGS. 4 and 8] comprises two components, a first section ‘p’ and a second section ‘q’, the first section ‘p’ of the locking bar 40 comprises a generally rectangular thin section metal plate comprising a main body 41 that has a first ‘rolled’ end 57 that is rolled over and back onto the main body 41 of the first section of the locking bar 40 where it is spot welded 47 to create part of a pivot connection. This part of a pivot connection is in the form of an enclosure that can receive a swivel pin 59a to connect the second section part ‘q’ of the locking bar 40 to the first section ‘p’ of the locking bar 40. A short narrow slot 53a is provided centrally in the first rolled end 57 to receive the reduced end 63 of the threaded bolt 60.

At the other end of the first section ‘p’ of the locking bar 40 a further rolled end 43 is provided that has a strengthening section in the form of an annular depression 44, the depression 44 provides additional strength to the rolled end 43 to increase its resistance to deformation. The depression 44 could be substituted with a rib if required. Preferably, the first section ‘p’ of the locking bar 40 is magnetic or is magnetised in order that said locking bar 40 when engaged in the latch opening in the strike plate will stay in position unaided.

The second section ‘q’ of the locking bar 40 comprises a short threaded bolt 60 the free end 62 of the bolt 60 defines a short portion of screw thread 61 which, in use, engages the threaded insert 70 in the portable lock body 1. The other end 63 of the bolt 60 defines a full radius and is reduced in width locally providing two flat surfaces 66 which allows the end 63 of the bolt 60 to be received in the slot 53a in the rolled end 57 of the first section ‘a’ of the locking bar 40. A small aperture 65 is provided in the end 63 of the bolt 60 which will align with the apertures 59 in the first section ‘p’ of the locking bar 40 to receive respectively the locking pin or swivel pin 59a, said swivel pin 59a will hingingly attach the first section ‘p’ and second section ‘q’ of the locking bar 40 together. The blind, threaded bore in the metal insert 70 will arrest inward travel of the locking bar 40 into the lock body 1a, when the rolled end 57 of the locking bar 40 will be abutting the inner surface 31b of the rubber insert 30 to retain said insert 30 in the lock body 1a.

An example of an adjustable ‘hook element’ for the first section ‘p’ of the locking bar 60 is illustrated in FIGS. 5 and 6, an adjustable ‘hook’ is essential where the gap between the door ‘y’ and door frame ‘x’ is wider than normal, simply making the ‘hook’ longer is not an option as latch cut-outs in normal door frames would not be deep enough to receive a long ‘hook’. A stud 43a with a very fine thread 43b is fixedly secured adjacent the free end of the first section ‘p’ of the locking bar 40 [the stud may be standard and secured by welding ‘w’, alternatively, a threaded weld stud or threaded clinch stud may be used] and a metal sleeve 48 with an internal thread 48a is screwed onto the stud 43a [ref FIG. 5], the metal sleeve 48 is preferably the same length as the stud 43a and defines knurling 48b on its outer surface for gripping purposes. To extend the length of the stud 43a the sleeve 48 is simply unscrewed on the stud 43a as required and after use screwed back fully onto the stud 43a. A cap with an internal thread [not shown] may be used as an alternative to the sleeve 48.

The cover 10 is a push-on interference fit into the plastic insert 30, the open front end 17 of the cover 10 receives part of the first section ‘p’ of the locking bar 40 when the portable lock is not in use. A tubular boss 15 extends centrally and internally from the closed end 12a of the cover 10, outwards and past its front face 14, a measure that provides that the front end 16 of the boss 15 will be flush with the step 32a in the rubber insert 30, when the cover 10 is engaged on the lock body 1a. The outside diameter of the boss 15 is dimensioned to be a snug interference fit in the internal aperture 32 in the rubber insert 30. Alternatively, the door lock as illustrated in FIG. 2 may be stored in the container 20 illustrated in FIGS. 11 and 15.

FIG. 2 is a side view and shows the portable lock A with its cover removed and the locking bar 40 in its fully stowed position, in which, it has been screwed fully into the threaded insert 70, the cover 10 may now be engaged on the lock body 1a.

FIG. 10 shows the portable door lock engaging a door ‘y’ and door frame ‘x’, the locking bar 40 with its hook projection 43 engaged in the aperture ‘m’ in the strike plate ‘k’ which is fixedly secured to the door frame ‘x’ and the door ‘y’ has been closed trapping the locking bar 40 between the door ‘y’ and door frame ‘x’, the portable lock is in its operational condition, the lock body 1a has been engaged on the threaded locking bar 40 and screwed thereon until the plastic or rubber insert 30 which forms the soft front face of the lock body 1a abuts the inner surface of the door ‘y’ and the outer surface of the moulding or architrave ‘z’ when the door ‘y’ is firmly and resiliently locked against unwanted entry. For stowage, the locking bar 40 is screwed fully into the lock body 1a [ref FIG. 2] and the cover 10 is applied [ref FIG. 1].

FIG. 10A depicts a thin gauge metal washer 9 with aperture 9a which is dimensioned to receive the body 31 of the rubber insert 30 said washer 9 is positioned against the underside 35 of the flange 34 of the insert 30, the washer 9 is preferably a tight fit on the body 31 and, in use, provides a metal to metal low friction contact between the rubber insert 30 and the lock body 1i as said body 1i is rotated relative to the rubber insert 30. The metal washer 9 is optional.

The portable door lock is arranged, in use, to absorb and cancel out pressure or impacts that may be applied to a door by a potential intruder, by protecting the anchor points of the striker plate ‘k’ which is fixedly secured to the door frame ‘x’ [sideways forces applied to the striker plate ‘k’ could possibly damage the door frame ‘x’] and also the integrity of the portable lock. Any attempt at forced entry will cause the door ‘y’ to push against the force of the very strong compression spring ‘1a’ which will absorb and mitigate the applied force. Should the portable door lock ever come under serious attack the spring damper element will also prevent possible damage to the door ‘y’ and door frame ‘x’ and the components of the portable door lock.

Referring now to FIGS. 11 to 16A, which illustrates another example of a portable door lock B, which utilises a very strong compression spring for the lock body 1b.

In this example, a plastic tubular container 20 is provided to stow the portable lock when it is not in use, said container 20 comprises a main body 20a with a closed back end 20c its front end 20d is open, a push-on cover 20b which has a closed back end 20e and an open front end 20f. The cover 20b comprises a thin walled tubular housing and in use receives part of the lock body 1b when the portable lock is not in use, a tubular boss 15a with a reduced diameter extends outwards of the cover 20b to provide an annular step 14a, the boss 15a is dimensioned to be a snug interference fit in the container body 20a.

FIG. 13 is a part cross sectional view of the portable door lock B stowed within the container 20, and FIG. 12 shows the container 20 when the cover 20b has been removed. FIG. 14 is a side view of the assembled door lock B prior to use and FIG. 16 is an exploded view showing the components of the portable lock B, the lock body 1b is almost identical to that in the previous embodiment. The threaded metal insert 70 [which may be a die casting] has an external thread 73a, to engage internally the spring coils 4a of the lock body 1b, an internally threaded aperture or bore 75 [not visible] in the metal insert 70 defines a square thread 75a to receive the bolt element 60 of the locking bar 40 which has a square thread 61b. The soft plastic or rubber insert 30 in this example defines a funnel formation 31a at its bottom end 33 which acts as a lead or guide for the threaded bolt portion 60 of the locking bar 40 into engagement with the threaded metal insert 70. The internal shoulder 31b of the loose fitting insert 30 is engaged by the rolled end 57 of the locking bar 40 when the portable lock B is being stowed to limit inward travel of the locking bar 40 and outward travel of the insert 30.

The locking bar 40 illustrated in FIG. 16A is an alternative to that of FIG. 16, its rolled end 43 defines a flat face 43a to engage the latch opening ‘m’ in the strike plate ‘k’ which is secured to the door frame ‘x’. The threaded bolt element 60 of the locking bar 40d defines a very coarse thread 61a which, in use, will screw directly into the closed coils 4a at the back end 3 of the lock body 1b. The large pitch of the thread 61a will facilitate quick engagement and disengagement of the portable lock B. The threaded portion at 61b of the bolt element 60 has been machined flat adjacent its free end 62 to provide two flat surfaces 61c which act as a handle for the user. The back end 3 of the lock body 1b may be closed with a vinyl plastic cover [not shown, ref FIG. 29] which will act as a non-slip handle for the portable lock B.

Referring now to FIG. 17, which illustrates a further alternative example of a portable door lock C in which a very strong compression spring 1c is used for the lock body.

In this example the spring housing 1c is generally cone shaped and defines several open coils 5 centrally therein, a number of the reduced diameter closed coils 4a form the back end 3 of the lock body 1c to receive the very coarse thread 61a on the threaded bolt element 60 of the locking bar 40, the spring coils 4a provide a very coarse internal screw thread which is compatible with the pitch of the screw thread 61a defined on the locking bar 40, the locking bar 40 screws directly into the spring coils 4a of the lock body 1c thereby eliminating the need for a separate threaded insert 70. The 3.5 mm-4 mm pitch of the coarse thread 61a of the locking bar 40 provides for quick engagement and removal of the portable lock C.

Referring now to FIGS. 18 to 19A, which illustrate a door lock D which incorporates an alternative locking bar 40a. In this example the threaded bolt element 60 of the locking bar 40 has been replaced by a flat metal plate 80 which defines a number of screw thread engaging teeth 86 on its side edges 85 and adjacent its free end 83, the other end of the metal plate 80 is reduced in width 84 and rolled over and back onto the main body 81 of the steel plate 80 where it is spot welded 89 or riveted to create part of a pivot connection. This part of a pivot connection is in the form of an enclosure that can receive a pivot pin or roll pin 59a to connect the second section ‘q’ of the locking bar 40a to the first section ‘p’ of the locking bar 40a. The slot 53a defined centrally in the first rolled end 57 of the locking bar 40a is dimensioned to receive the rolled end 84 of the metal plate 80 which provides an aperture 87 [not visible] which will align with the aperture 59 in the first section ‘p’ of the locking bar 40a, said aligned apertures respectively, receive a pivot pin 59a which will hingingly attach the first section ‘p’ and the second section ‘q’ of the locking bar 40a together.

The thread engaging teeth defined on the edges 85 of the metal plate 80 have a pitch which corresponds with the very coarse internal pitch of the tightly wound spring coils 4a which define the back end 3 of the lock body 1d providing for very quick engagement and disengagement of the lock body 1d.

Referring now to FIGS. 20 to 22 which illustrate another example of a portable door lock E in which the lock body comprises a very strong compression spring 1e.

The compression spring 1e which forms the lock body is generally cone shaped and formed from square section spring steel wire, conical coils 6 define the back end 3 of the lock body 1e and are tightly coiled, the aperture 7 in the back end of the spring 1e is dimensioned to receive the metal threaded insert 70a which has a large diameter shallow head 72, said shallow head 72 defines an inward projecting protrusion 77 adjacent its periphery which provides that when the metal insert 70a is entered into the aperture 7 in the back end of the spring 1e the protrusion 77 is arranged to abut the free end 8 of the spring wire and provides that when the locknut 79 is screwed tightly onto the external thread 73 of the metal insert 70b [from inside the spring 1e], the protrusion 77 will lock the metal insert 70a against rotation relative to the spring 1e [ref FIG. 20]. The screw thread 61 on the threaded bolt element 60 of the locking bar 40 screws into a blind threaded bore 75 [not visible] in the metal insert 70a, said screw thread 61 limits inward travel of the locking bar 40 into the metal insert 70a, which acts to limit inward travel of the locking bar 40 into the housing 1e. A number of spaced or open coils 5 are provided centrally in the compression spring 1e which will provide strong resistance to compression. The rubber or plastic insert 30 is a loose fit in the front end 2a of the lock body 1e but on stowage is held captive therein by the rolled end 57 of the locking bar 40.

Referring now to FIGS. 23 to 25 which illustrate a further example of a portable door lock F which utilises a very strong compression spring 1f as the lock body.

The plastic cover 10 and plastic or rubber insert 30 are standard for round or square wire springs, in this example the threaded bolt element of the locking bar 40b defines a square section thread 61b which will screw into the evenly spaced apart, small diameter coils 7 at the back end of the lock body 1f.

The spring 1f is generally cone shaped, reducing in diameter toward its back end 3, large diameter closed coils 4 are defined at the front end 2 of the spring 1f and several open coils 5 in the centre of said spring 1f, a number of reduced diameter, parallel spring coil 7 define the back end 3 of the spring 1f, a small gap 7a is provided between the evenly spaced spring coils 7 and is dimensioned to receive and engage the square section thread 61b defined on the bolt element 60a on the locking bar 40b, the spring coils 7 act as a screw thread for the locking bar 40b, the spring coils 7 and the screw thread 61b have the same pitch. In this example, as with the examples of FIGS. 17 and 18 the locking bar 40b screws directly onto the spring coils 7 of the lock body 1f, thereby eliminates the need for a separate metal threaded insert 70. The rolled end 57 of the locking bar 40 will retain the rubber insert 30 in the lock body 1f on stowage.

Referring now to FIGS. 26 to 28, which illustrate a further example of a portable door lock G, which has a very strong compression spring 1h as the lock body or housing.

The portable lock comprises a body 1g in the form of a compression spring, a threaded locking bar 40, a plastic or rubber insert 30a and a thin walled, threaded liner 90.

This example is very similar to that illustrated in FIG. 17 in that the very coarse thread 61a on the threaded bolt element 60 screws directly into the closed spring coils 4b of the lock body 1g, said screw thread 61a acts to limit inward travel of the locking bar 40 into the lock body 1g and provides for quick engagement and disengagement of said lock body 1g. A thin walled tubular plastic sleeve or liner 90 is provided which defines a very coarse thread 91 on its external surface said thread 91 corresponds with the internal pitch of the spring coils 4 which form the front end 2 of the spring housing 1g, a very thin flange 94 is defined at the top end 92 of the liner 90 to limit the amount said liner 90 can be screwed into the lock body 1g. The outside diameter of the flange 94 matches the outside diameter of the spring coils 4, FIG. 30 shows the plastic liner 90 screwed fully and tightly into the coils 4 of the lock body 1g to become a fixture therein.

The plastic or rubber insert 30a in this example defines an annular bead 37 externally thereon and adjacent its bottom end 33, the insert 30a is a force fit into the plastic liner 90 until its annular bead 37 locates behind the end 93 of the liner 90 [ref FIG. 31], said insert 30a is then captive in the plastic liner 90 but is free to rotate therein. An internal annular ledge 31b [not visible] is provided internally in the insert 30a and adjacent its bottom end 33 said ledge 31b will limit travel of the locking bar 40 into the lock body 1g when the portable lock G is being stowed.

The insert 30a defines the soft front face of the lock body 1g and will prevent scuffing or marking of the door and associated door frame or moulding secured thereto, in use, as the lock body 1g is being screwed onto the locking bar 40, and as it is being tightened thereon the soft insert 30a will grip the door and the door frame and stop rotating with the lock body 1g and will thereby provide a buffer between the door and frame rather than a rotating force, as the lock body 1g and plastic sleeve 90 rotate on and relative to the soft rubber insert 30a.

Referring now to FIGS. 29 to 32, which illustrate a portable door lock H which utilises a strong compression spring as a damper element.

The portable lock H comprises a body 29, a rubber insert 30, a threaded locking bar 40, a strong compression spring 1h and a cover 10b.

In this example a lock body 29 preferably fabricated from metal is generally tubular in form, its bottom end 29c defines a boss or reduced diameter 29d which is dimensioned to be a very tight fit inside the front end 2 of the spring 1h, the closed parallel spring coils 4 at the front end 2 of said spring 1h securely attach the spring to the lock body 29, best illustrated in FIG. 31 [alternatively, the boss 29 may define an external screw thread and the spring 1h screw onto the boss 29d or a screw thread may be provided on the inside wall 29g of the boss 29d to receive the spring 1h], the loose rubber insert 30 is also shown engaged in the front end 29b of the lock body 29 said insert 30 providing the soft front face of the lock body 29, the bottom end 33 of the insert 30 is supported on the annular ledge 29f in the lock body 29 and on stowage, when the portable lock H is not in use the rolled end 57 of the locking bar 40 abuts the inner surface 31b of the insert 30 to hold it captive in the body 29 or housing and to also limit movement of the locking bar 40 inwards of the body 29 or housing when the end 62 of the locking bar 40 will be aligned with the bottom end 3 of the damper spring 1h. FIG. 31 also illustrates an insert 30 which may be made from a hard thermoplastic material or produced as a metal die casting, the front end 32 of the insert 30 supports an elastomeric over mould 32b which provides the soft front face of the insert 30. The undercut 23b in the lock body 29 is to receive the snap beads 31a on the insert 30.

The cover 10b is a push fit onto the lock body 29, its front end 10e locating on the annular ledge 29e externally on the lock body 29, three or more spaced vertical fit ribs 10d are provided internally in the cover 10b.

FIG. 32 shows the portable door lock with the locking bar 40 in its stowed position and FIG. 29 is a side view of the fully assembled lock H, when the cover 10b has been engaged and the vinyl plastic end cap 100 has been secured to the back end 3 of the spring 1h said end cap 100 acts as a non-slip handle when turning the lock housing on the locking bar 40.

The hook projection 43e on the locking bar 40 [also ref FIG. 42] comprises a short metal stud and may be welded to the main body 41 of the locking bar 40, the curved or radiused end 43d of said body 41 prevents it from engaging a recessed latch cut-out 23b in the door ‘y’ when the door is being opened to remove the locking bar 40. The hook projection 43e may comprise a self-clinching stud or pin which does not require welding.

In use, the lock housing, comprising the body 29 and damper spring 1h can be screwed onto the locking bar 40 when the rubber insert 30 will grip the door ‘y’ and door frame ‘x’ and the housing 29 will carry on rotating on and relative to the rubber insert 30 as the housing 29 is fully tightened against the door ‘y’ and door frame ‘x’.

Referring now to FIGS. 33 to 36, which illustrate a portable door lock I in which a strong compression spring is contained within the lock housing.

The portable lock I comprises a metal housing 21, a compression spring Ii, a rubber or plastic insert 30. a threaded locking bar 40 and a plastic cover 10b.

The lock body or housing 21 comprises a generally cone shaped enclosure preferably fabricated from aluminium or steel its front end 23a is open and its back end 24 is closed, a narrow annular ledge 26 is provided internally within the housing 21 close to its front end 23a said ledge 26 supports the bottom end 33 of the rubber insert 30. A very coarse screw thread 27 is defined in the internal wall 29 of the housing 21 said screw thread 27 extends from the annular ledge 26 inwards of the housing approximately 10 mm and is to receive the closed coils 4 at the front end of the spring 1i. An annular ledge 29e is defined externally in the housing 21 close to its front end 23a to support the lock cover 10b the front end 10e of which locates on the ledge 29e. Knurling 21b is defined on the outer surface of the housing 21 adjacent its back end 24 to provide a non-slip surface by means of which the housing 21 is turned, [alternatively, the back end 24 of the housing 21 may be open and the spring 1i assembled in the housing 21 via its back end 24 which may be closed with a plastic plug].

The compression spring 1i is generally cone shaped and comprises two or three large diameter closed coils 4 at the front end 2 of the spring, two or more open coils 5 [active coils which provide the damper effect] with a slightly smaller diameter than said closed coils 4 make up the mid portion of the spring 1i and six or more smaller diameter closed coils 4a define the back end of the spring 1i, it is the coils 4a that, in use, are engaged by the threaded bolt element 60 of the locking bar 40, the bolt element 60 is free to pass through the spring coils 4 and 5 respectively [ref FIG. 30].

The spring 1i is fixedly secured in the housing 21, the closed coils 4 at the front end 2 of said spring have an external pitch that corresponds with the screw thread 27 in the housing 21 this allows the spring 1i to be screwed into the housing until its top end 2 is flush with the annular ledge 26 when the spring 1i is tightly and resiliently locked therein [ref FIG. 36].

The loose fitting rubber insert 30 locates in the front end 23 of the housing 21 and provides the soft front face of said housing, the bottom end 33 of the insert 30 locates on the annular ledge 26 said insert 30 is arranged to limit movement of the locking bar 40 inwards of the housing 21, the insert 30, on stowage, is retained in the housing by the locking bar 40. The portable lock cover 10b is a push fit onto the front end of the housing 21 [ref FIGS. 29 to 32].

FIG. 34 shows the portable lock I in its operational condition after the housing 21 has been engaged on the threaded locking bar 40 said locking bar having been screwed into the coils 4a on the free end 3 of the compression spring 1i until the rubber insert 30 which forms the front face of the housing 21 abuts the inner surface of the door ‘y’ and the architrave or moulding ‘z’ when the door ‘y’ is firmly locked against unwanted entry.

Quite often the latch plate 6 is recessed, set below the surface of the door, this results in an abutment face 23b which is a problem if the free end of the body 41 of the locking bar 40 is flat and when said locking bar is being removed, a locking bar body with a flat end can engage the face 23b and prevent the door ‘y’ from opening giving the impression that the locking bar 40 cannot be removed this can result in damage to the door edge, it is for this reason the free end of the body 41 is curved 43d [ref also FIGS. 32 and 42]. Clearly, this problem could be mitigated by simply making the locking bar body 41 longer, however, this would increase the overall length of the portable lock which is not desirable for obvious reasons.

Referring now to FIGS. 37 to 39, which illustrate a portable door lock which does not incorporate a spring damper element.

The portable lock in this example comprises a lock body or housing 21, a plastic cover 10b, a threaded locking bar 40 and a rubber or plastic insert 30.

The lock housing 21 is very similar to the housing in the previous embodiment and comprises a generally cone shaped container preferably fabricated from aluminium with an open front end 23a and its narrow back end 24 is closed, the aperture 23 in the front end of the housing 21 is dimensioned to receive the body 31 of the rubber insert 30, an undercut 23b is defined internally in the housing 21 adjacent its front end 23a said undercut 23b is to receive an annular bead or a number of protrusions 31a which depend from the side 31 of the rubber insert 30 and which allow the insert 30 to snap-engage the housing 21 to be captive therein but to remain a loose fit and free to rotate relative to the housing 21. A threaded blind bore 27 extends centrally from adjacent the back end 24a of the housing to close to the middle of said housing 21 said blind bore 27 is to receive the threaded locking bar 40. The internal wall of the housing is reduced in diameter 29 this provides a lead-in or guide for the threaded bolt element 60 of the locking bar 40. The annular ledge 29e defined externally on the housing 21 is to support the front face 10e of the lock cover 10d.

Knurling 21a is applied to the outer surface of the housing 21 adjacent its back end 24 to provide a non-slip surface when screwing the lock housing 21 onto the threaded locking bar 40. The fact that the back end of the housing 21 has a reduced diameter is important as some door knobs and handles are very large and can obstruct the application of the lock when it is required to pivot at an acute angle. As an alternative, the rubber insert 30 may be manufactured as a metal pressing with elastomeric material applied to the front face of the flange 34.

Referring now to FIGS. 40 to 43, which illustrate a further portable door lock K which does not incorporate a spring damper element.

The portable door lock comprises a plastic lock body or housing 21, a plastic cover 10b, a threaded locking bar 40 and a rubber or plastic insert 30.

In this example, which is almost identical to the previous example of FIGS. 37 to 39, the housing 21 is preferably manufactured as a plastic moulding from nylon or other suitable, strong thermoplastic material and is generally cone shaped, the front end 23 of the housing is dimensioned to receive the body 31 of the rubber insert 30, the back end 24 of the housing 21 is much narrower than its front end 23a. A threaded blind bore 27 extends centrally and longitudinally from the back end 24a to approximately the middle of the housing 21 said blind bore 27 defines a square thread 27a with a large pitch which will provide enhanced resistance to any force applied to the portable lock, a corresponding thread 61a is defined on the bolt element 60 of the locking bar 40. A thread pitch of for example 4 mm will facilitate very fast installation and removal of the portable lock. Alternatively, a separate threaded metal insert may be secured in the housing 21 during or after the moulding process.

The annular ledge 29e defined externally on the housing 21 is to support the cover 10b. A number of raised longitudinal ribs 21b are provided adjacent the back end 24 of the housing 21 to provide a non-slip gripping surface. FIG. 40 shows the portable lock K in its operational condition.

Referring now to FIGS. 44 to 48, which illustrates a portable door lock which incorporates a resiliently deformable material as a damper element, for example, an elastomeric material or open cell composite or laminate capable of absorbing an impact force that is applied to a door whose opening has been limited.

The portable door lock comprises a lock body 29, a rubber or plastic insert 30, a threaded locking bar 40, a resiliently deformable damper block 8, a threaded metal insert 70 and a plastic cover 10b.

The lock body 29 in this example is preferably fabricated from aluminium or steel and is generally tubular and very similar to the lock body illustrated in the previous example of FIGS. 29 to 31. The front end 29b of the lock body 29 is dimensioned to receive the body 31 of the rubber insert 30 which is a loose fit therein and provides the soft front face of the lock body 29. The deformable damper block 8 is generally round and elongate and defines a longitudinal hexagonal aperture 8c through its centre, an annular ledge 8d is defined externally on the damper block 8 adjacent its front end 8a, the reduced diameter 8e at the front end of the damper block 8 is dimensioned to be a tight fit in the aperture 29c in the back end of the body 29 and is also secured therein with suitable adhesive. A large headed metal insert 70 with an internally threaded blind bore 75 and a hexagonal body 73a is a force fit into the hexagonal aperture 8c and at the back end 8b of the damper block 8, the large head 72 of the insert 70 is dimensioned to match the back end 8b of the damper block 8 [ref FIG. 47]. The threaded bore 75 in the insert 70 is to receive the screw thread 61 on the bolt element 60 of the locking bar 40.

The cover 10b is a push fit onto the lock body 29 its front face 10e supported on the annular ledge 29e on said lock body 29. On stowage, the rolled end 57 of the locking bar 40 abuts the inside surface 31b of the rubber insert 30 to hold said insert 30 in the lock body 29 the insert 30 also limits movement of the locking bar 40 inwards of the housing.

In use, the lock housing which comprises the lock body 29, damper block 8 and the threaded metal insert 70 can be rotated relative to the rubber insert 30 which will grab the inner surface of the door ‘y’ and the door frame ‘x’ or architrave ‘z’ as pressure is applied by the housing as it is turned on the threaded locking bar 40 and relative to the insert 30 which acts as a buffer and not a rotating force between the lock housing and the door ‘y’ and the door frame ‘x’ or architrave ‘z’.

FIG. 48 illustrates an alternative example of the second section ‘p’ of the locking bar 40 which is produced as a metal extrusion in for example brass or other suitable material.

The rubber insert 30 could be fixed relative to the lock body 29 and would provide the soft front face of the lock body 29, however, as the insert is rotated with the lock body it would cause scuffing and may mark the surface of the door ‘y’ and door frame ‘x’ or architrave ‘z’, which is not desirable.

An elastomeric over mould could be applied directly onto the front end or face 2 of the compression spring body or housing also directly onto the front face of the metal or plastic bodies or housings disclosed in this specification, eliminating the need for a rubber or plastic insert 30 but this would result in scuffing and possible damage to the door ‘y’ and door frame ‘x’ or architrave ‘z’.

Where possible, the same numerals have been used throughout this specification to denote similar components and parts thereof.

1-19. (canceled)

20. A portable door locking device comprising:
a locking bar having a first section and a second section pivotally connected to the first section, the second section being provided with at least one section of enlarged thickness compared with another section of the second section; and
a resiliently yieldable section;
wherein the locking bar is at least partially received within the resiliently yieldable section.

21. The portable door locking device according to claim 20, wherein the first section of the locking bar is provided with a threaded section.

22. The portable door locking device according to claim 21, wherein the threaded section directly engages the resiliently yieldable section.

23. The portable door locking device according to claim 21, wherein the threaded section engages an insert that contacts the yieldable section.

24. The portable door locking device according to claim 20, wherein the resiliently yieldable section is a spring and the threaded section directly engages coils of the spring.

25. The portable door locking device according to claim 24, wherein the spring is a compression spring or a tension spring.

26. The portable door locking device according to claim 20, wherein the yieldable section comprises a material selected from the group consisting of one or more of a metallic material, a plastics material, and a polymeric material.

27. The portable door locking device according to claim 20, wherein the second section of the locking bar is substantially planar and the section of enlarged thickness comprises a protrusion.

28. The portable door locking device according to claim 20, wherein the second section of the locking bar is substantially planar and the section of enlarged thickness comprises a rolled back portion of the locking bar.

29. The portable door locking device according to claim 28, wherein the rolled back portion of the locking bar comprises a groove therein.

30. The portable door locking device according to claim 20, wherein the resiliently yieldable section has a yieldable section front face through which the locking bar extends, and wherein the yieldable section front face comprises a front face of yieldable material.

31. The portable door locking device according to claim 30, wherein the front face of yieldable material is a polymeric material.

32. The portable door locking device according to claim 30, wherein the yieldable section front face is connected to the resiliently yieldable section and is captive therein whilst being free to rotate relatively to the resiliently yieldable section.

33. The portable door locking device according to claim 20, wherein a position of the section of enlarged thickness of the locking bar is axially adjustable relative to the resiliently yieldable section.

34. The portable door locking device according to claim 33, wherein the position of the section of enlarged thickness of the locking bar is axially adjusted by rotation of the locking bar.

35. The portable door locking device according to claim 20, wherein at least the second section of the locking bar is magnetic.

36. The portable door locking device according to claim 20, wherein the resiliently yieldable section comprises a connection mechanism including a first part and a second part being a cover section, and wherein the first and second parts of the connection mechanism are engageable, at least part of the locking bar that extends from the resiliently yieldable section is receivable within the cover section.

37. The portable door locking device according to claim 36, wherein, when the resiliently yieldable section and the cover section are engaged with one another, the portable door locking device takes a form of a bottle shaped capsule, and wherein the cover section comprises a removable lid section.

38. The portable door locking device according to claim 20, wherein both ends of the second section of the locking bar are rolled back onto itself and at least one of the ends is secured thereon.

39. A portable door locking device comprising:
a locking bar having a first section and a second section pivotally connected to the first section, the second section being provided with at least one section of enlarged thickness compared with another section of the second section, the first section of the locking bar is provided with a threaded section; and
a resiliently yieldable section;
wherein the locking bar is at least partially received within the resiliently yieldable section;
wherein the threaded section directly engages the resiliently yieldable section.
